(19) United States
(12) Patent Application Publication
(10) Pub. No.: US 2003/0124964 A1
(43) Pub. Date: Jul. 3, 2003

(54) Apparatus for securing a fish

(76) Inventor: Jack L. Congialosi, New Baltimore, MI (US)

Correspondence Address: Gregory T. Zalecki, Suite 415, 12900 Hall Rd., Sterling Heights, MI, 48313, US

(21) Appl. No.: 10/035,069

(22) Filed: Jan. 3, 2002

(51) Int. Cl. A22C 29/02

(52) U.S. Cl. 452/6

(57) ABSTRACT

An apparatus for securing a fish during the process of fileting or scaling the fish. The apparatus is comprised of a handle, a body and one or more tines. The handle is shaped to be grasped within one hand. The body is attached to the handle. The one or more tines are substantially perpendicularly attached to the body for securing the fish to a solid surface. The optimal angle between the body and the one or more tines is approximately 115 degrees. Preferably, the distal end of the body is flared to increase the number of tines which may be attached to it. Preferably, a squeegee is attached to the side of the body opposite the one or more tines, to promote easy removal of fish remnants. The apparatus may also be used for securing other types of meat.

### BACKGROUND

Fish have been caught and used for food throughout recorded history. After fish have been caught, they need to be properly prepared before they can be satisfactorily used for food. A common method of preparation is called fileting. Fileting is a process wherein the edible meaty portion of the fish is removed from the body of the fish and prepared for consumption.

When a fish is fileted a knife is used to separate the meaty portion of the fish from the fish body and the fish skin. In order to perform this process the fish needs to be secured to a solid surface. Several methods for securing the fish have been used traditionally. The most difficult method is to hold the fish down by bare hand. The slipperiness of most fish makes this difficult. Alternatively, the fish can be secured to the surface by pliers, by nailing the fish to the surface, by use of a clamp attached to the surface or by the use of special gloves. The special gloves typically have a rough surface on their inner aspect for enhanced efficiency when grasping the fish, as well as some type of protective coating on the outer aspect of their surface to protect each hand from being cut by the knife or by fish parts such as scales and gills.

Numerous problems are associated with these traditional methods of securing the fish in preparation to fileting or scaling the fish. If additional or different equipment is used, such as pliers, nails, clamps or special gloves, that equipment needs to be procured. Difficulties are often encountered in securing the fish to the solid surface by hand, with pliers, with a clamp or with a nail because of the slipperiness of the fish. The use of any of these methods results in the hand and fingers of the person involved being in close proximity to the fileting knife, as well as being in close proximity to the gills and scales of the fish, thereby causing an increased risk of personal injury.

When many fish are being fileted, the fileting process can be a long and arduous process. The process is often accompanied by hand and finger fatigue and pain. The hands and fingers often come into contact with the internal organs of the fish and other fish parts. This is not only objectionable to many people, but it can also cause a softening of the fingers and fingernails, thereby causing further discomfort and delay during the fileting process. Internal fish organs and fish parts accumulate on the solid surface during the fileting process and need to be efficiently and comfortably removed.

Another method of preparing fish as food involves scaling of the fish. Many fish are naturally covered with hard and sharp objects known as scales. It is often desirable to remove the scales from the fish. When the fish is scaled, it is secured to a solid surface and a scaling tool is scraped across the scaled area of the fish, thereby causing the removal of the scales.

There is a need for a handheld apparatus for efficiently securing a fish to a solid surface for fileting or scaling the fish. There is also a need for such a handheld apparatus which can also be used to efficiently remove fish remnants from the solid surface.

### SUMMARY

The present invention is directed to an apparatus for securing a fish that satisfies these needs. It is comprised of a handle, a body and one or more tines. The handle is shaped to be held within one hand. It permits the apparatus to be grasped. The body is attached to the handle. The distal end of the body is shaped to receive one or more tines. One or more tines are substantially perpendicularly attached to the body such that the angle between the tines and the body is approximately a right angle. The tines are shaped to secure the fish, typically by penetrating the fish. The apparatus secures the fish to a solid surface when pressure is applied to the handle by hand, thereby transmitting a securing force to the fish and the solid surface.

In one version of the invention a squeegee is attached to the side of the body opposite the one or more tines. The squeegee can be used for removing fish remnants from the solid surface.

Preferably, the angle between the body and the one or more tines is approximately 115 degrees. This permits optimal transfer of the hand applied force to the fish. This force optimization can also be achieved, instead, by implementing an angle of approximately 155 degrees between the body and the handle, while the body-tines angle is aright angle.

The preferred version of the invention uses a body having a flared end. The end of the body opposite the handle is flared so that that end is wider than the other end. The widening of the flared end serves several purposes. It allows more tines to be attached to the body, thereby allowing bigger fish to be secured and enhancing the securing force. It also allows a longer squeegee to be attached to the body. A longer squeegee enhances the efficiency of the removal of the fish remnants.

Although the primary use of this apparatus is to secure fish, it can also be used to secure other types of meat, such as beef or poultry. When meat is prepared for eating, problems similar to those encountered when fileting fish are encountered. The meat tends to be slippery and difficult to secure to a solid surface while being prepared. This apparatus can be used to secure the meat to a solid surface, while it is being prepared, in the same manner that a fish can be secured to a solid surface as described above.

### DRAWINGS

These and other features, aspects, and advantages of the present invention will become better understood with regard to the following description, appended claims, and accompanying drawings where:

FIG. 1 is a perspective view of the preferred embodiment of an apparatus for securing a fish.

FIG. 2 is a perspective view showing fish meat removed from the fish, before removal of the rib cage, the fish meat being secured by the apparatus for securing a fish of FIG. 1.

FIG. 3 is a perspective view of the fish meat of FIG. 2, showing the rib cage and skin of the fish.

FIG. 4 is a perspective view of the fish meat of FIG. 3, showing the skin of the fish being secured by the apparatus for securing a fish of FIG. 1, while the fish fillet is being removed from the skin.

FIG. 5 is a top plan view showing the apparatus for securing a fish of FIG. 1, with its orientation reversed, being used to remove fish remnants from a solid surface.

FIG. 6 is a side view of a version of the apparatus for securing a fish of FIG. 1, showing the optimal angle between the tines and body of the apparatus and also showing a fish being secured to the solid surface of FIG. 5.

FIG. 7 is a perspective view of the apparatus for securing a fish of FIG. 1, showing the tines attached to the body of the apparatus.

### DESCRIPTION

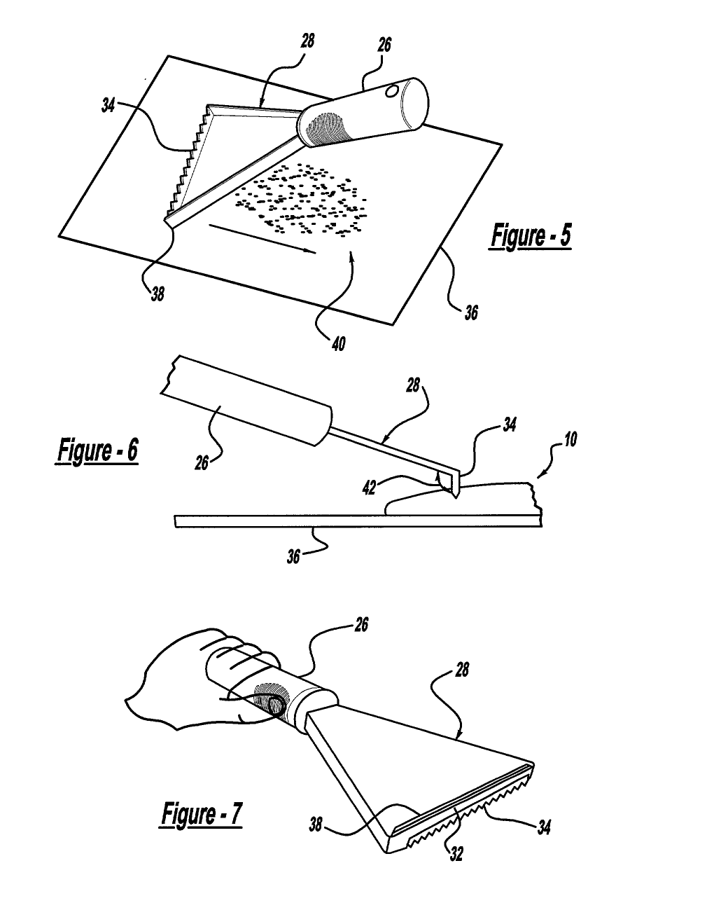

Several embodiments of this invention are shown in FIGS. 1 through 7. The invention is intended primarily for fileting fish. A handle 26 is shaped for holding within one hand. The handle is intended for grasping the apparatus and applying pressure to the fish to be fileted. A body 28 is attached to the handle 26. The body has a distal end 32. Preferably, the distal end 32 is flared 30. The distal end 32 is shaped to receive one or more tines 34. One or more tines 34 are substantially perpendicularly attached to the distal end of the body 32 for securing the fish 10 to a solid surface 36. The solid surface 36 is used as a surface upon which the fish 10 may be fileted. A squeegee 38 is attached to the distal end of the body 32 on the side of the body opposite the one or more tines 34 for removing fish remnants 40 from the solid surface 36.

The flaring of the distal end of the body 32 permits additional tines 34 to be attached to the body 28. The additional tines 34 and additional width of the body 28 at its distal end 32 enhance the fish holding capabilities of the apparatus and allow bigger fish to be secured. The flaring of the distal end of the body 32 also permits a longer squeegee 38 to be used. A longer squeegee 38 enhances the speed and efficiency of the removal of the fish remnants 40 from the solid surface 36.

Preferably, the angle 42 between the bottom of the body 28 and the one or more tines 34 is approximately 115 degrees. This will result in optimal leverage when applying hand pressure to the fish 10 with the apparatus 8. Alternatively, an angle of approximately 155 degrees may be used as the angle of attachment between the top of the handle 26 and the top of the body 28.

Preferably, the handle 26 and body 28 are constructed by plastic injection molding. The handle 26 may have a rubber cover for enhanced comfort and to allow more secure gripping. The tines 34 are preferably constructed from stainless-steel to enhance corrosion resistance. Galvanized steel or high carbon steel may also be used for the construction of the tines 34. Galvanized steel is corrosion resistant, while high carbon steel is strong, durable and malleable. The tines 34 may also be constructed from injection molded plastic. The lowest manufacturing costs is probably obtained by constructing the handle 26, body 28, tines 34 and squeegee 38 by plastic injection molding.

The preferred material for constructing the squeegee 38 is rubber. Rubber will provide optimal performance of the squeegee when it is used to remove fish remnants.

There are several techniques for attaching the tines 34 to the body 28. When the tines 34 and body 28 are constructed by injection molding, they become one integral piece and no separate method of attachment is needed. When the tines 34 are constructed from steel they may be force fit to the body 28. A cavity is created within the body 28 which is sized to securely retain an assembly of tines 34, which assembly is pressed into the cavity. The tines 34 may also be secured to the body 28 with an adhesive. Alternatively, the tines 34 may be fused or molded into the body 28.

The apparatus for fileting a fish 8 significantly enhances the ease and efficiency of fileting fish. The fish 10 is laid upon the solid surface 36. The person performing the fileting process grasps the handle 26 of the apparatus 8 and applies pressure with the tines 34 to the head 12 of the fish. This secures the fish 10 to the solid surface 36. With the fish 10 so secured, a cut with a fileting knife 44 is made behind the head 12 and gills 14 of the fish. Fish meat 18 is then separated from the body of the fish by cutting with the fileting knife 44 along the backbone of the fish to the tail of the fish 20.

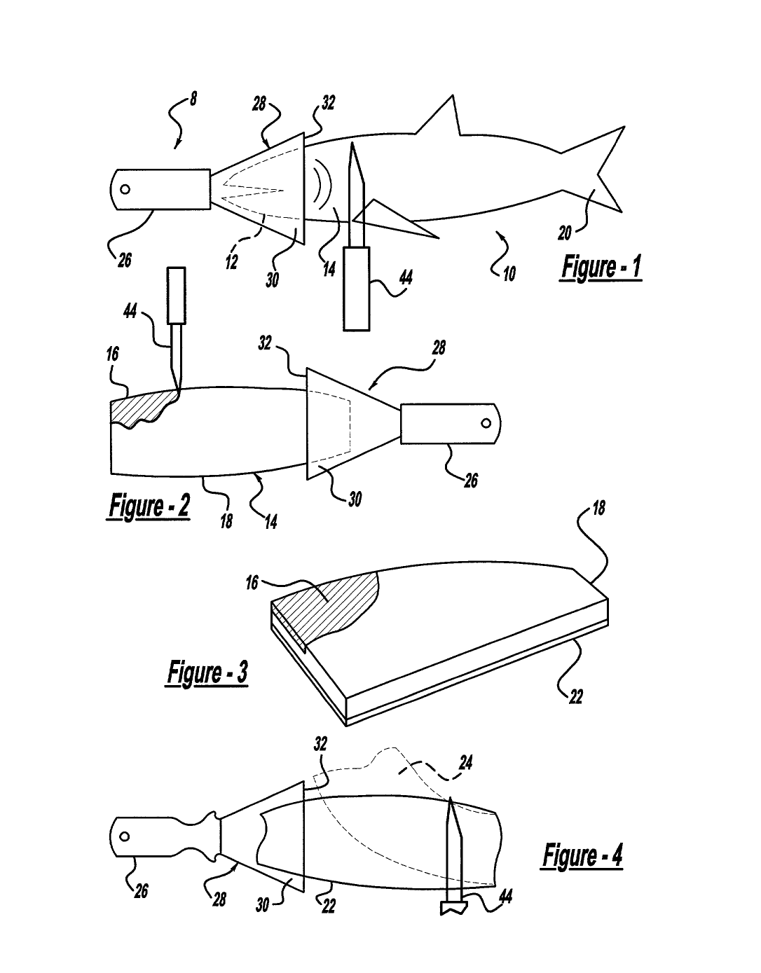

The fish meat 18 is turned over and laid upon the solid surface 36, as shown in FIG. 2. A rib cage 16 usually remains attached to the fish meat 18. The end of the fish meat 18 opposite the rib cage 16 is secured to the solid surface 36 with the apparatus 8 using the same method that was used for securing the head 12 of the fish 10, as previously described. The fileting knife 44 is then used to remove the rib cage 16 from the fish meat 18.

Fish skin 22 remains attached to the fish meat 18. A portion of the fish skin 22 is separated from one end of the fish meat 18. Pressure is applied with the apparatus 8 to the separated end of the fish skin 22 as shown in FIG. 4, thereby securing the fish skin 22 to the solid surface 36. The fileting knife 44 is then inserted between the fish skin 22 and the remaining fish meat 18. A fish filet 24 is separated from the fish skin 22 by cutting with the fileting knife 44 along the entire length of the fish meat 18.

After one or more fish are fileted the solid surface 36 is contaminated with fish remnants 40. The apparatus 8 is turned over. A sweeping motion of the apparatus 8, as shown in FIG. 5, is used to remove the fish remnants 40 from the solid surface 36 with the squeegee 38.

The apparatus 8 may also be used when scaling a fish. The fish 10 is secured to the solid surface 36 with the apparatus 8 as indicated above. A scaling tool, with pressure applied, is then transversely brushed across the fish, against the grain of the scales, thereby removing the scales.

What is claimed is:

1. An apparatus for securing a fish, the apparatus comprising:
(a) a handle shaped to be held by one hand, for grasping the apparatus;
(b) a body attached to the handle, the distal end of the body being shaped to receive one or more tines; and
(c) one or more tines shaped to secure the fish, the tines being substantially perpendicularly attached to the body, for securing the fish to a solid surface by hand.

2. The apparatus for securing a fish recited in claim 1, further comprising a squeegee attached to the side of the body opposite the one or more tines, for removing fish remnants from the solid surface.

3. The apparatus for securing a fish recited in claim 1, wherein the angle between the body and the one or more tines is approximately 115 degrees.

4. The apparatus for securing a fish recited in claim 1, wherein the angle between the body and the handle is approximately 155 degrees.

5. The apparatus for securing a fish recited in claim 2, wherein the angle between the body and the one or more tines is approximately 115 degrees.

6. The apparatus for securing a fish recited in claim 2, wherein the angle between the body and the handle is approximately 155 degrees.

7. An apparatus for securing a fish, the apparatus comprising:
(a) a handle shaped to be held by one hand, for grasping the apparatus;
(b) a body attached to the handle, the body having a flared end opposite the handle, the flared end being shaped to receive one or more tines; and
(c) one or more tines shaped to secure the fish, the tines being substantially perpendicularly attached to the body, for securing the fish to a solid surface by hand.

8. The apparatus for securing a fish recited in claim 7, further comprising a squeegee attached to the side of the body opposite the one or more tines, for removing fish remnants from the solid surface.

9. The apparatus for securing a fish recited in claim 7, wherein the angle between the body and the one or more tines is approximately 115 degrees.

10. The apparatus for securing a fish recited in claim 7, wherein the angle between the body and the handle is approximately 155 degrees.

11. The apparatus for securing a fish recited in claim 8, wherein the angle between the body and the one or more tines is approximately 115 degrees.

12. The apparatus for securing a fish recited in claim 8, wherein the angle between the body and the handle is approximately 155 degrees.

13. An apparatus for securing meat, the apparatus comprising:
(a) a handle shaped to be held by one hand, for grasping the apparatus;
(b) a body attached to the handle, the body having a flared end opposite the handle, the flared end being shaped to receive one or more tines; and
(c) one or more tines shaped to secure the meat, the tines being substantially perpendicularly attached to the body, for securing the meat to a solid surface by hand.

14. The apparatus for securing meat recited in claim 13, further comprising a squeegee attached to the side of the body opposite the one or more tines, for removing meat remnants from the solid surface.

15. The apparatus for securing meat recited in claim 13, wherein the angle between the body and the one or more tines is approximately 115 degrees.

16. The apparatus for securing meat recited in claim 13, wherein the angle between the body and the handle is approximately 155 degrees.

17. apparatus for securing meat recited in claim 14, wherein the angle between the body and the one or more tines is approximately 115 degrees.

18. The apparatus for securing meat recited in claim 14, wherein the angle between the body and the handle is approximately 155 degrees.
